(19) United States
(12) Patent Application Publication
(10) Pub. No.: US 2002/0169641 A1
(43) Pub. Date: Nov. 14, 2002

(54) Method of qualifying a renter

(76) Inventor: Elbie D. Wallace JR., Charlotte, NC (US)

Correspondence Address: DOUGHERTY & CLEMENTS LLP, Suite 400, 6230 Fairview Road, Charlotte, NC, 28210, US

(21) Appl. No.: 09/852,867

(22) Filed: May 10, 2001

(51) Int. Cl. G06F 17/60

(52) U.S. Cl. 705/4

(57) ABSTRACT

The invention is a method wherein a third party, a guarantor, runs a qualifying check on a potential renter. If a potential renter qualifies against the guarantor's criteria which are less demanding than the conventional criteria used by typical apartment complex management, the guarantor warrants the landlord (apartment complex management) against default by the renter. With this degree of assurance, the landlord is willing to lease the space.

### FIELD OF THE INVENTION

The present invention relates to a method of enabling access to rental housing by potential renters who do not qualify by conventional leasing standards. Particularly, the method includes establishment of a warranty against rent default by a renter so that the landlord grants a lease to the renter.

### BACKGROUND OF THE INVENTION

Many individuals have marginal creditworthiness. For example, a history of slow payment of debts or a bankruptcy can produce a negative credit report. A young person may have marginal creditworthiness simply by lacking a credit history. Presently, such individuals are rejected by landlords when they apply to rent housing based on a creditworthiness report from one of the retail credit reporting companies. When this happens, the rejected individual is forced to reside in publicly subsidized housing which may be inferior to rental housing being sought, by requiring, for example, a substantially longer commute to the potential landlord's place of employment or living in a less desirable neighborhood.

A typical rental process sequence is:

A potential renter applies to an apartment complex to rent available space.

The management of the apartment complex runs a credit check and a background check consisting of a search for disqualifying criminal history.

If the potential renter fails to qualify, the rental does not take place.

Often the rejection is based on marginal creditworthiness due to poor credit history or no credit history. Neither the potential landlord nor the management of the apartment complex has any recourse when this occurs. What is needed is a mechanism whereby potential renters who do not qualify on conventional grounds can have a chance to rent a desired residential space.

### SUMMARY OF THE INVENTION

The invention is a method wherein a third party, a guarantor, runs a qualifying check on a potential renter. If the potential renter qualifies against the guarantor's criteria, which are less demanding than the conventional criteria used by typical apartment complex management, the guarantor warrants the landlord (apartment complex management) against default by the renter. With this degree of assurance, the landlord is willing to enter into the lease.

According to the present invention, the method of a guarantor warrantying a landlord against rent default by the renter includes verifying the potential renter against lease warranty criteria by the lease guarantor. Qualifying the renter against a lease warranty includes the steps of: 1) qualifying the renter against the background check, 2) qualifying the renter against a modified credit check, and 3) qualifying the renter against an employment check. Where a renter qualifies against these checks, the guarantor provides a warranty to the landlord against default by the renter in exchange for the landlord granting a lease to the renter.

According to another aspect of the present invention, the background check includes investigating the renter's background for a felony and denying the warranty if the renter has a felony conviction. Additionally, the modified credit check includes reviewing the renter's credit for past due utility bills and denying the warranty if the renter has a past due utility bill.

According to a further aspect of the present invention, the employment check includes the steps of: 1) verifying that the renter is currently employed, 2) verifying that the renter has been continuously employed for a specified number of months, such as eight, 3) verifying that the renter's annual income is at least a certain minimum amount, such as Fifteen Thousand Dollars ($15,000), and 4) verifying that the renter has attained a specified age, such as, at least twenty one years.

According to a still further aspect of the present invention, the warranty covers the payment of a remaining portion of the lease if there is default by the renter. Additionally, the method includes the step of paying the guarantor a fee for the warranty.

According to another aspect of the present invention, the renter can remotely apply to qualify for the lease warranty by completing a guarantor's application on an Internet website.

According to a further aspect of the present invention, the method can include the step of providing a data base of landlords who would be willing to accept the warranty by the guarantor. Additionally, the method can include the step of notifying the landlords listed on the data base via the Internet of a renter who is qualified by the guarantor.

### OBJECTS OF THE INVENTION

The principal object of the present invention is to provide a means for individuals who are applying for a lease, but who do not qualify against conventional creditworthiness criteria, to be qualified under less stringent criteria with a third party, whereupon the third party warrants the landlord against default by the potential renter and the previously unobtainable lease agreement may be consummated.

### BRIEF DESCRIPTION OF THE DRAWINGS

The foregoing and other objects will become more readily apparent by referring to the following detailed description and the appended drawings in which:

FIG. 1 is diagrammatic flow chart of the invented method; and

FIG. 2 is a diagrammatic flow chart of FIG. 1 listing additional steps.

### DETAILED DESCRIPTION

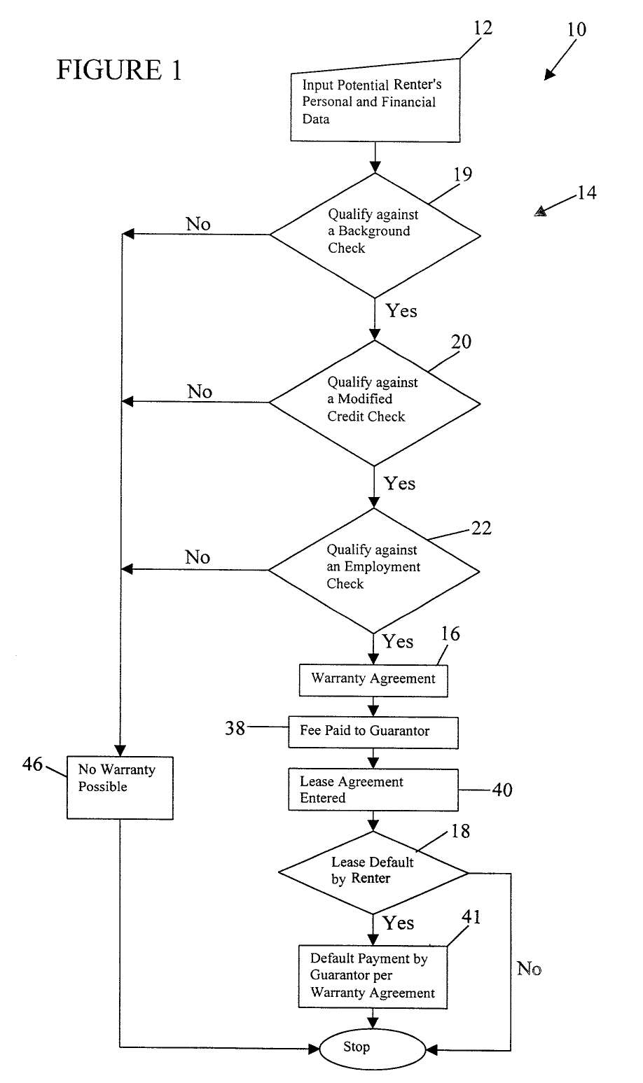

The present invention provides a method for enabling access to leased housing to a potential renter who does not qualify against conventional leasing standards. As shown in FIG. 1, the invented method 10 includes inputting and processing personal and financial data 12 to qualifying the potential renter against a lease warranty criteria 14. If the renter qualifies, then a lease guarantor warranties 16 the lease against default 18 by the renter. Prior art methods utilize a background check and a credit check to determine if a lease will be granted to the renter. The background check includes review of the renter's criminal record. If a significant criminal record is found, then no lease is possible. A potential renter that meets the background check is further processed by a retail credit check generally via telecommunication means. The credit check includes review for judgment for non-payment, bankruptcy, automobile repossession, medical bills, utilities, student loans, and no credit. Aside from student loans and no credit, default on any of the retail credit check categories results in a “no lease possible” outcome.

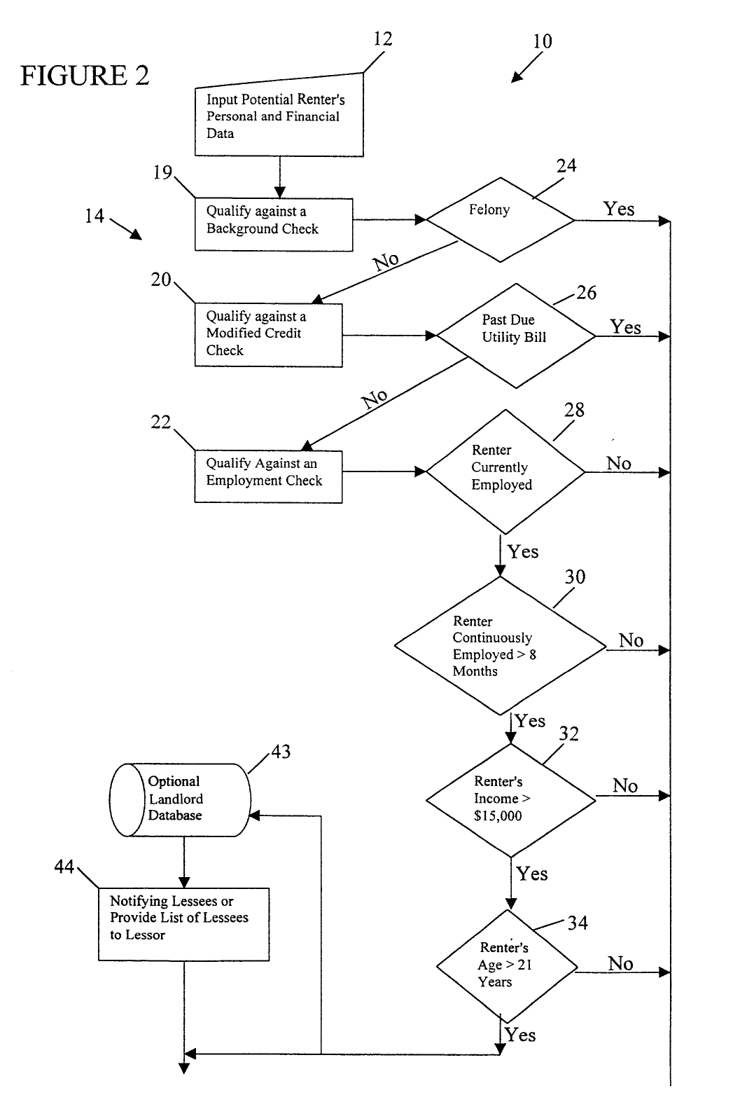

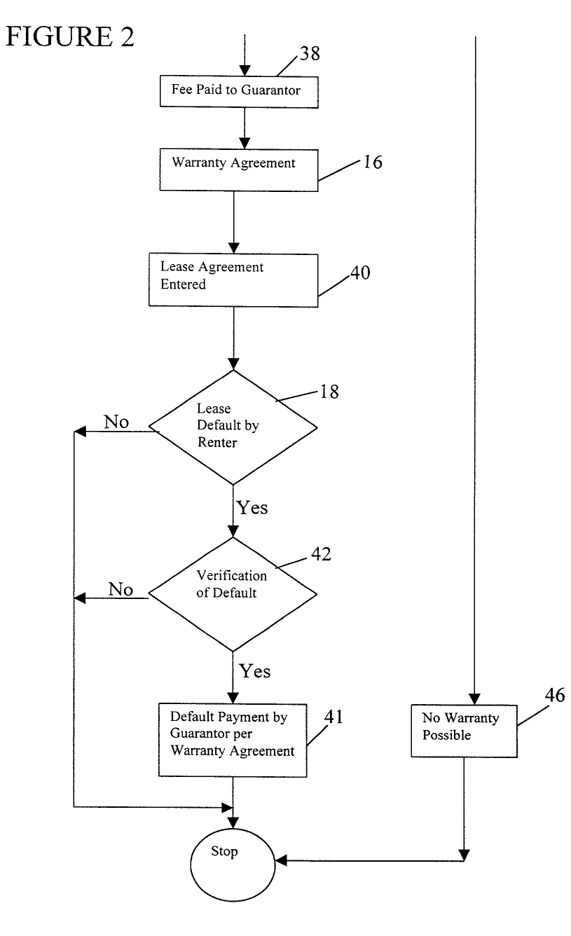

As illustrated in FIG. 2, a renter denied a lease under prior art methods may still be able to obtain a lease by using the method 10 of the present invention. Under the present invention, the lease guarantor qualifies the potential renter against the lease warranty criteria 14. If the renter is approved, the guarantor warranties 16 the landlord against default 18 by the renter. The lease warranty criteria 14 includes: 1) qualifying the renter against the background check 19; 2) qualifying the renter against a modified credit check 20; and 3) qualifying the renter against an employment check 22. The background check 19 is similar to prior art background checks in that the renter will not qualify if they had been convicted of a felony 24.

The modified credit check 20 can include review of the same information as the prior art credit check. However, automatic rejection from qualifying occurs only when the renter is in default of paying a utility bill 26. Consequently, the renter can be approved despite having a judgment against him for non-payment, bankruptcy, automobile repossession, medical bills or student loans, or no credit.

The employment check 22 includes the steps of: 1) verifying that the renter is currently employed 28, 2) verifying that the renter has been continuously employed for the previous specified number of (eight) months 30, 3) verifying that the renter's annual income is at least a certain amount (Fifteen Thousand Dollars ($15,000)) 32, and 4) verifying that the renter's age is at least twenty-one years 34. Additionally, the employment check 22 can require that the renter's annual income is at least fifty times the amount of monthly rent. An alternative method adjusts the required annual income 32 by any method such as, for example, a fixed percent, the cost of living index as of Jan. 1, 2001, a fixed amount, etc.

Where the renter qualifies against the lease warranty criteria 14, the guarantor enters a warranty agreement 16 with the landlord against default 18 of rent payment by the renter. In consideration of warranting 16 the lease, the guarantor receives a fee 38 and the landlord enters a lease agreement 40 with the renter. The warranty 16 provides that upon default 18 of rent payment by the renter, the guarantor will provide default payment 41 for at least a portion of the remaining term of the lease. The default payment 41 can be limited such as, for example, to cover only two months of the remaining months of the lease. Additionally, the warranty 16 can be limited in duration. For example, the warranty 16 can extend for only a portion of the lease agreement 40 such as covering only the first half of the lease. Typically, the obligation under the warranty 16 will not become effective until there is verification 42 that the renter is in default 18. Methods for verifying 42 that the renter is in default 18 include: 1) an ejectment conviction, and 2) verification that the renter has abandoned the leasehold by physical inspection by or on behalf of the guarantor.

The fee 38 to the guarantor is typically paid by the renter. The fee 38 can be determined by any of a variety of methods. For example, the fee 38 can be based according to a percent of the annual rental rate, or a percent of the renter's annual income, or graduated according to a range of the annual rental price or a range of the renter's annual income. Additionally, the fee 38 can be adjusted upward or downward depending on the number of misdemeanor convictions and/or the extent of defaults as indicated by a standard background check. Typically, bankruptcy will result in the fee being adjusted upward by a multiplier such as, for example, by a factor from 1.1 to 1.5.

An Internet website can also be provided so that the renter can remotely input personal and financial data 12 to apply to qualify for the lease warranty 16 by completing and submitting an online application. The fields of the application are to be completed with information sufficient for the background check 18, modified credit check 20 and employment check 22 to be conducted. Examples of appropriate fields include the potential renter's name, address, Social Security Number, name of employers over the previous eight months, telephone numbers of such employers, date of birth, number of consecutive months employed, etc.

A data base 43 can be provided of landlords who would grant a lease to a renter based on the warranty by the guarantor. The landlords can be notified 44 via the Internet, or by any other method, of a renter who is qualified by the guarantor. Also, a list of landlords can be provided to the renter.

The steps of the method 10 can be performed by a computer software program. Entry into the program includes the results of the background check 19, the modified credit check 20 and the employment check 22. Where the renter does not qualify against the lease warranty criteria 14, the program outputs that no warranty is possible 46. Where the renter qualifies against the lease warranty criteria 14, the program outputs the guarantor fee agreement 38, the range of rent in which the warranty 16 is valid and a list of landlords 43 who would be willing to enter a warranted lease agreement 40.

### SUMMARY OF THE ACHIEVEMENT OF THE OBJECTS OF THE INVENTION

From the foregoing, it is readily apparent that I have invented a method whereby individuals who are applying for a lease but who do not qualify against conventional creditworthiness criteria can be qualified under less stringent criteria with a third party where upon the third party warrants the landlord against default by the potential renter and the previously unobtainable lease agreement may be consummated.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

What is claimed is:

1. A method of enabling access to leased housing to a potential renter who does not qualify against conventional leasing standards comprising:
a. qualifying the potential renter against a lease warranty criteria by a lease guarantor including:
i. qualifying the renter against a background check;
ii. qualifying the renter against a modified credit check; and
iii. qualifying the renter against an employment check, and
b. warrantying a landlord by the lease guarantor against default by the renter whereby the landlord grants a lease to the renter based on a warranty by the guarantor.

2. The method of claim 1 wherein the background check includes checking the renter's background for a felony and denying the warranty if the renter has the felony conviction and wherein the modified credit check includes checking the renter's credit for a past due utility bill and denying the warranty if the renter has a past due utility bill.

3. The method of claim 2 wherein the employment check includes the steps of:
a. verifying that the renter is currently employed;
b. verifying that the renter has been continuously employed for the previous 8 months;
c. verifying that the renter's annual income is at least $15,000; and
d. verifying that the renter's age is at least 21 years old.

4. The method of claim 3 wherein the renter's annual income is at least 50 times the amount of monthly rent.

5. The method of claim 3 wherein the potential renter's annual income is at least $15,000 adjusted by the cost of living index as of a predetermined date.

6. The method of claim 5 wherein the renter is qualified against the lease warranty criteria regardless of judgment for non-payment of rent, bankruptcy, automobile repossession, unpaid medical bills, unpaid student loans and lack of credit.

7. The method of claim 6 wherein the warranty includes a default payment of at least a portion of the remaining rent of the lease after default.

8. The method of claim 7 wherein the default payment does not exceed two months.

9. The method of claim 7 wherein the warranty is valid during at least a portion of the lease.

10. The method of claim 9 wherein the warranty is valid only during the first half of the lease period.

11. The method of claim 9 further comprising the step of paying to the guarantor a fee for the warranty.

12. The method of claim 11 wherein the fee is based according to a percent of the annual rental price.

13. The method of claim 11 wherein the fee is based according to a percent of the renter's annual income.

14. The method of claim 11 wherein the fee is graduated and fixed based according to a range of the annual rental price or a range of the renter's annual income.

15. The method of claim 11 wherein the fee is increased by a factor of from 1.1 to 1.5 when the renter had filed for bankruptcy.

16. The method of claim 11 wherein an ejectment conviction is required before the renter is in default.

17. The method of claim 16 further including the step of the potential renter completing a guarantor's application on an Internet web-site to qualify the renter against the lease warranty criteria.

18. The method of claim 16 further including the step of providing a data base of landlords who would accept a warranty by the guarantor.

19. The method of claim 18 further including the step of notifying the landlord in the data base, via the Internet, of a renter qualified by the guarantor.

20. The method of claim 11 further including the steps of inputting information provided by the background check, the modified credit check and the employment check into a computer program whereby the program determines if the renter qualifies against the background check, the modified credit check and the employment check;
outputting a guarantor's fee agreement when the renter qualifies against the lease warranty criteria; and
outputting a list of landlords who are willing to enter into a warranted lease agreement.
